(19) United States
(12) Patent Application Publication
(10) Pub. No.: US 2025/0289678 A1
(43) Pub. Date: Sep. 18, 2025

(54) SENSING HEAD, EDGE SENSOR AS WELL AS UNIT

(71) Applicant: Brückner Maschinenbau GmbH, Siegsdorf (DE)

(72) Inventors: Florian SOLLACHER, Bergen (DE); Thomas ROTT, Siegsdorf (DE); Christoph HÖGLAUER, Waging am See (DE)

(21) Appl. No.: 19/076,303

(22) Filed: Mar. 11, 2025

(30) Foreign Application Priority Data
Mar. 12, 2024 (DE) 10 2024 107 021.8

(51) Int. Cl. B65H 23/02; G01V 9/00

(52) U.S. Cl. CPC B65H 23/0212; G01V 9/00; B65H 2553/10; B65H 2701/10

(57) ABSTRACT

A sensing head for a pneumatic edge sensor for detecting the position of an edge (K) of a material web (B), such as a film web, is disclosed having a head part and a sensing zone. Both the first section and the second section include a fluid port, ducts and a sensing area with openings, wherein the sensing areas of the first section and the second section delimit the sensing zone. The sensing zone is connected to the fluid port of the first section and the second section each by means of a fluid connection, in which the fluid connection at least in part is realised through the openings and the ducts of the corresponding section.

### CROSS REFERENCE TO RELATED APPLICATION

This application claims priority to German Patent Application Number DE 10 2024 107 021.8, filed Mar. 12, 2024, the entire contents of which is hereby incorporated by reference.

### BACKGROUND

The disclosure relates to a sensing head for a pneumatic edge sensor, a pneumatic edge sensor as well as a unit for producing a material web.

Units for producing a material web are known and guide a material web during operation. To this end, different guiding devices are known that can grip and move the edge of the material web.

However, the position of the material web and thus the position of the edges change during operation permanently so that is necessary to permanently measure the position of the edges.

To this end, pneumatic edge sensors are known that provide a sensing zone, in which the edge runs, by means of a sensing head.

On the one side of the sensing zone or the material web, for example the upper side, compressed air is introduced into the sensing zone and the pressure on the other side of the sensing zone is measured, i.e. on the other side of the material web. In the case of known sensing heads, only a part of the sensing zone can actually be used however and a precise determination of the position is difficult as the measured pressure does not change linearly with the position of the edge.

### SUMMARY

The disclosure provides a sensing head, an edge sensor as well as a unit, by means of which the position of the edge on a material web can be determined particularly precisely.

The object is solved by means of a sensing head for a pneumatic edge sensor for detecting the position of an edge of a material web, in particular a film web, comprising a head part and a sensing zone. The head part comprises a first section and a second section, wherein the sensing zone is located between the first section and the second section. Both the first section and the second section comprise a fluid port, a plurality of ducts and a sensing area with openings. The sensing areas of the first section and the second section delimit the sensing zone, wherein the sensing zone is connected to the fluid port of the first section by means of a fluid connection through the first section. The fluid connection is realised at least in part through the openings and the ducts of the first section. The sensing zone is connected to the fluid port of the second section by means of a fluid connection through the second section, wherein the fluid connection is realised at least in part through the openings and the ducts of the second section.

Through the use of a plurality of ducts and corresponding openings in the sensing area, compressed air is introduced into and air is removed from the sensing zone across a large region of the sensing zone in a targeted way. Through the openings and ducts, it is simultaneously possible that a particularly homogeneous flow is formed through the sensing zone.

In this way, a larger region of the sensing zone is available for a measurement so that a larger spatial sensing region is available for the position of the edge. At the same time, the linearity of the pressure drop that is associated with the change in the position of the edge improves, thereby making considerably more precise measurements possible.

The material web can be a plastic film, a paper web, a textile web or a web made of another knitted fabric or material that can be stretched.

For example, the fluid connections run completely within the corresponding section, wherein each of the ducts opens into one of the openings of the sensing area of the corresponding section.

The ducts can taper towards the openings and can comprise in particular a larger opening width at the end facing the fluid port as at the openings. In this way, the flow properties are improved further.

In an embodiment, the ducts run at least in part in an arc, in particular which extend through an angle of between 80° and 100°, in particular through an angle of 90° so that turbulences that would impair the quality of the measurement are also reliably avoided in the case of an angled fluid connection.

To reduce turbulences further and thus improve the quality of the measurement further, the ducts can have a length of more than 5 mm, in particular more than 10 mm, and/or have a length that is larger than triple the opening width of one of the openings.

In one aspect, the opening direction of the fluid port of the first section and/or the second section is angled, in particular perpendicular to the opening direction of the openings of the sensing area of the first section and/or the second section. In this way, the sensing head can be connected simply.

The opening direction of the fluid port can extend in the longitudinal direction, transverse direction or vertical direction.

For example, the opening directions of the fluid ports of the first section and the second section extend parallel to each other.

In an embodiment, the sensing area of the first section and the sensing area of the second section are opposite each other, in particular, they are parallel to each other. In this way, a rectilinear flow is ensured through the sensing zone that improves the quality of the measurement further.

For a particularly rectilinear flow, the sensing area can be flat and/or only be provided on one side of the corresponding section.

In an embodiment, the sensing areas of the first section and the second section are spaced apart from each other in the vertical direction of the sensing head. The openings of the sensing area of the first section and/or the sensing area of the second section are located adjacent to each other in the longitudinal direction and/or the transverse direction, thereby achieving particularly uniform flow.

For example, the openings of the sensing area of the first section and/or the sensing area of the second section are arranged in at least a row that extends in particular in the longitudinal direction. As a result, the flow through the sensing region is uniform, in particular in the longitudinal direction, thereby increasing the linearity of the measurement further.

In an embodiment, at least two rows of openings are provided that are located adjacent to each other in the transverse direction, in particular wherein the openings form a regular grid. Measuring accuracy can be increased further through the use of multiple rows.

For example, the openings of two adjacent rows are arranged offset to each other in order to cover the sensing zone as completely as possible.

For example, two rows each comprising five openings are provided on each of the sensing areas. More or fewer than two rows each comprising more or fewer than five openings is also conceivable.

In one aspect, the openings of the sensing area of the first section and the opposing opening of the sensing area of the second section are aligned to each other in order to reduce turbulences further and thus increase the quality of the measurement further.

In an embodiment, the first section and the second section are designed together as a single piece, in particular wherein the entire sensing head is a single piece. As a result, the openings of the sensing areas can be aligned precisely to each other without any adjustment.

The head part is, for example, made of a plastic and, for example, produced by means of an additive manufacturing process, such as 3D printing. For example, polyamide 12 (PA12) is suited as a material for manufacturing by means of 3D printing and/or, for example, multi jet fusion is suited as a manufacturing process.

The use of polyether ether ketone (PEEK), polyether ketone ketone (PEKK), aluminium or steel are also conceivable for the manufacture of the head part by means of 3D printing. Other materials that are resistant to deformation at temperatures exceeding 80° C. can also be used.

Similarly, the use of stereolithography (SLA) or selective laser sintering (SLS) is conceivable.

For example, the head part comprises a C-shape, viewed in side view in the transverse direction. Another shape of the head part is also conceivable, provided that an edge of a material web can be guided through the two sections of this shape.

In an embodiment, a transition cavity is arranged in the first section and/or in the second section, into said transition cavity the fluid port and the ducts of the corresponding sections open, in particular wherein the fluid port and the ducts open into the transition cavity on the opposing sides. Through the transition cavity, the flow of compressed air can be distributed evenly to all the ducts or be combined from all ducts without the ducts influencing each other.

In particular, the fluid connection comprises the transition cavity and the ducts.

The object is also solved by means of an edge sensor for detecting the position of an edge of a material web, in particular a film web. The edge sensor has a sensing head as previously described, a compressed air source and a pressure sensor, wherein the compressed air source and the pressure sensor are connected fluidly to different fluid ports of the sensing head.

The features and advantages described for the sensing head apply equally to the edge sensor and vice versa.

The fluid connection occurs, for example, by means of fluid lines, such as pipes and/or tubes.

Moreover, the object is solved by means of a unit for producing a material web, in particular a film production unit, comprising an edge sensor as described previously, in particular wherein the material web extends through the sensing zone.

The features and advantages discussed for the sensing head and/or the edge sensor equally apply to the unit and vice versa.

### BRIEF DESCRIPTION OF THE DRAWINGS

Additional features and advantages of the disclosure are found in the following description as well as the attached drawings to which reference is made. In the drawings:

FIG. 1 shows a schematic view of a unit according to an exemplary embodiment comprising an edge sensor and a sensing head.

FIG. 2 shows a schematic view of an entry area of an oven of the unit according to FIG. 1 comprising edge sensors, and

FIGS. 3 and 4 show a sensing head of the edge sensors according to FIG. 2 in a perspective view and a schematic sectional view.

### DETAILED DESCRIPTION

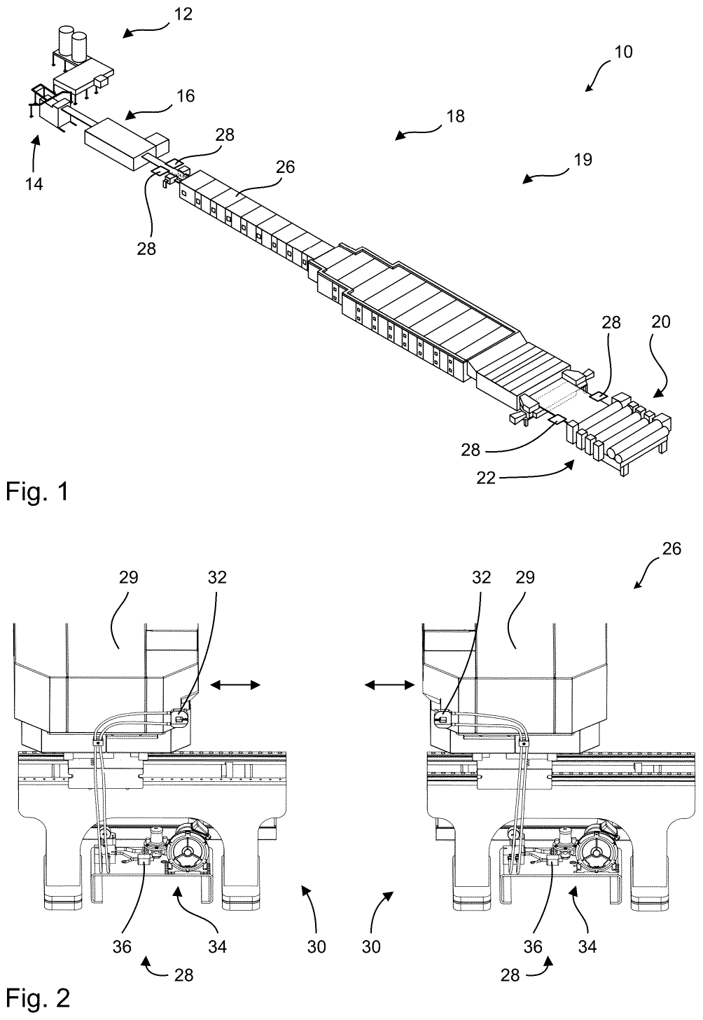

In FIG. 1, a unit 10 for producing a material web B is shown extremely schematically, which comprises several different units and devices.

In the shown example, the unit 10 is a film production unit, by means of which-without any limitation in the scope of the protection—the disclosure is explained exemplarily.

In this case, the material web B is a plastics film. It is also conceivable that the material web B can be a paper web, a textile web or a web made of another knitted fabric or material that can be stretched.

In the shown example, the unit 10 comprises an extrusion unit 12, a cast rolling system 14, at least one stretching unit—such as a machine direction orienter 16 (MDO), a transverse direction orienter 18 (TDO)—, a draw roller unit and/or an edge treatment device 20 as well as a winder unit 22.

The film produced is, for example, a biaxially stretched film, such as polypropylene (BOPP), polyethylene terephthalate (BOPET), polyamide film (BOPA), polyethylene film (BOPE), polylactic acid film (BOPLA), capacitor film (BOPP-C) or battery separator film (BSF).

To produce plastic films, a film is created on the chill roll of a cast rolling system 14 by means of an extrusion unit 12. To this end, the extrusion unit 12 generates a melt from the starting products, such as granular material, said melt being applied to the chill roll, thereby creating the film.

This film is conveyed from the cast rolling system 14 to the machine direction orienter 16 as a material web B. In the machine direction orienter 16, the film is stretched in the machine direction in order to obtain the film.

In the machine direction orienter 16, the film runs over a plurality of rollers that are heated in order to heat the film to the desired temperature so it can be stretched.

Between at least two of the rollers present in the machine direction orienter 16, the stretching is carried out in the machine direction, i.e. in the drawing direction, so that the film becomes a stretched film.

The film obtained is conveyed from the machine direction orienter 16 to the transverse direction orienter 18 and stretched in the transverse direction orienter 18 in the transverse direction.

Along the drawing direction of the unit 10, the transverse direction orienter 18 has an oven 26 comprising different zones for treating the film.

The film is heated in the first zone, also termed the preheating zone. In the subsequent second zone (“stretching zone”), the film is stretched in the transverse direction so that its width is greater and its thickness is less at the end of the second zone than it was at the start.

After completing the stretching, the film then passes through the third and further zones (termed “heat treatment zone”, “further heating zone” and/or “annealing zone”), in which a relaxation of the film, for example, can take place at high temperatures.

Subsequently, the film passes through a further zone (“cooling zone”), wherein the film is cooled in the last zone.

A further zone is termed the neutral zone and serves to separate the zones. The neutral zone is, for example, an empty space without any ventilation.

The zones of the transverse direction orienter 18 can also be divided differently and/or designed differently in their lengths. For example, fewer or shorter neutral zones can be provided, or the neutral zones can be arranged at other points, also additionally. Changes to the remaining zones are also conceivable.

Following the transverse direction orienter 18, the now biaxially stretched film runs through the draw roller unit and/or the edge treatment device 20 and is wound by means of the winder unit 22.

It is also conceivable that the unit 10 is designed in another way, for example having a simultaneous stretching unit 19 comprising an oven 26 as a stretching unit alternatively or in addition to the machine direction orienter 16 and/or to the transverse direction orienter 18.

To be capable of guiding the material web B in the unit 10 in a targeted manner, the unit 10 comprises multiple edge sensors 28.

These may be arranged at different locations of the unit 10 in order to determine the position of the edge of the material web B exactly at these locations. This is important, for example, when winding the material web B onto the winder unit 22 or when being introduced into the oven 26 of the transverse direction orienter 18. The exact detection of the position of the edge of the material web B is also important for the edge treatment device 20, for example in order to be capable of positioning the edge treatment device 20 accordingly.

In FIG. 2, the entry area of the transverse direction orienter 18 into the oven 26 is shown exemplarily in a perspective view schematically.

The transverse direction orienter 18 comprises two guiding devices 29 which are spaced apart from each other and which can each grip and guide an edge of the material web B.

Each of the guiding devices 29 is moveable laterally by means of a moving apparatus 30, i.e. towards the opposing guiding device 29 or away from it.

In addition, each of the guiding devices 29 comprise an edge sensor 32, by means of which the position of the edge of the material web B can be detected. The signal of the edge sensor 32, i.e. the position of the edge of the material web B, is used as control variable for the adjustment of the guiding device 29 by means of the moving apparatus 30.

The shown edge sensors 28 comprise a sensing head 32, a compressed air source 34 as well as a pressure sensor 36.

Each of the edge sensors 28 have at least one sensing head 32 and one pressure sensor 36.

It is conceivable that multiple edge sensors 28 have a shared compressed air source 34.

The compressed air source 34 is connected to the sensing head 32 by means of fluid lines, for example pipes and/or tubes. In turn, the sensing head 32 is connected fluidly to the pressure sensor 36 via fluid lines.

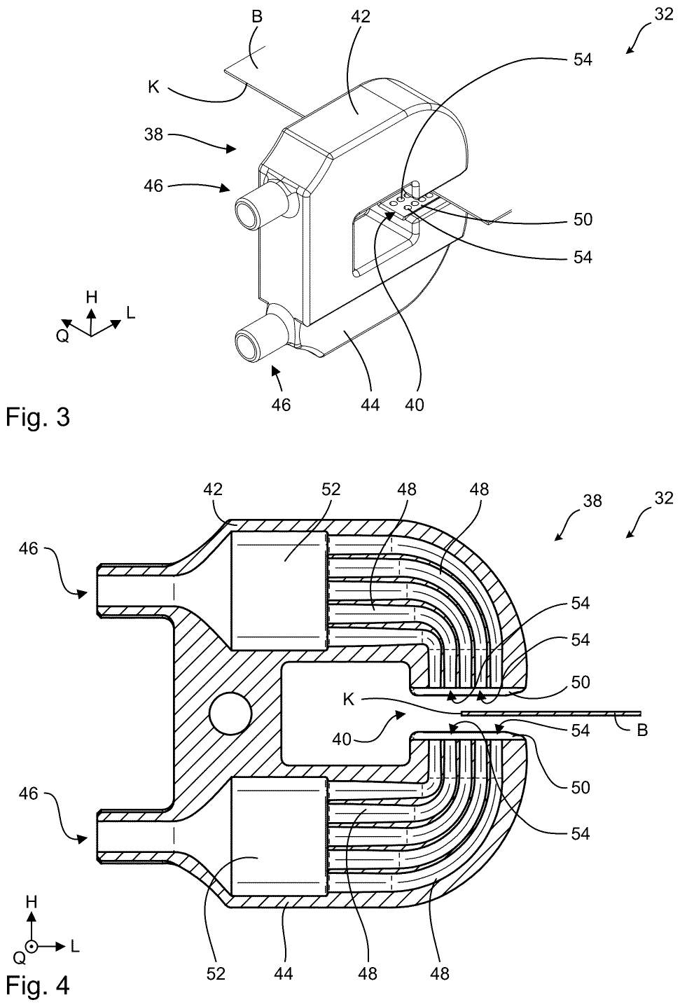

The sensing head 32 is shown schematically in FIG. 3 and shown in a sectional view in FIG. 4, whereby the section runs through a row of openings.

The sensing head 32 has a head part 38 and a sensing zone 40, through which the head part 38 is defined.

The head part 38 comprises a first section 42 and a second section 44; in particular, the head part 38 comprises the first second 42 and the second section 44.

In the shown embodiment, the first section 42 and the second section 44 are designed together as a single piece, in particular wherein the entire sensing head 32 is a single piece.

The head part 38 and thus the first section 42 and the second section 44 are made of, for example, a plastic and are produced, for example, by means of an additive manufacturing process, such as 3D printing. Polyamide 12 (PA12) is suited as material, for example, for manufacturing by means of 3D printing and/or multi jet fusion is suited as manufacturing process.

The use of polyether ether ketone (PEEK), polyether ketone ketone (PEKK), aluminium or steel are also conceivable for the manufacture of the head part 38 by means of 3D printing. Other materials that are resistant to deformation at temperatures exceeding 80° C. can also be used.

Similarly, the use of stereolithography (SLA) or selective laser sintering (SLS) is conceivable for the manufacture of the head part 38.

Similarly, the head part can be a casting made of plastic or metal, i.e. can be produced by means of a casting process.

It is also conceivable that the first section 42 and the second section 44 are separate parts, which are fixed to one another for the manufacture of the head part 38.

The sensing head 32 comprises a longitudinal direction L, a transverse direction Q and a vertical direction H. The material web B extends in the longitudinal direction L as well as the in the transverse direction Q, wherein the material web B moves in the transverse direction Q. Accordingly, the edge K of the material web B also runs in the transverse direction Q.

The first section 42 and the second section 44 are arranged above each other in relation to the vertical direction H.

For example, the head part 38 has a C-shape, in a view in the transverse direction Q on the side of the head part 38.

Both the first section 42 and the second section 44 each comprise a fluid port 46, a plurality of ducts 48, a sensing area 50 as well as optionally a transition cavity 52.

The fluid ports 46 are arranged on the side of the head part 38 facing away from the material web B in relation to the longitudinal direction L. The opening direction of the fluid ports 46 is also in the longitudinal direction L. It is however conceivable that the opening direction of the fluid ports 46 extends in the transverse direction Q or the vertical direction H. It is similarly conceivable that the opening direction does not solely extend in the longitudinal direction L, i.e. also extends additionally in the transverse direction Q and/or in the vertical direction H.

The opening directions of the fluid ports 46 extend parallel to each other.

It is also conceivable that the opening directions of the fluid ports 46 do not extend parallel to each other.

On the end of the head part 38 facing away from the material web B, the first section 42 and the second section 44 each comprise said one sensing area 50.

The sensing areas 50 each comprise a plurality of openings 54.

In the shown embodiment, the sensing areas 50 of the first section 42 and the second section 44 extend parallel to each other and parallel to the material web B, i.e. in the transverse direction Q and the longitudinal direction L.

The sensing areas 50 are, for example, flat. In the shown embodiment, they are only arranged on one side of the corresponding section 42, 44 and thus do not extend on different sides.

The sensing areas 50 are opposite each other in the shown embodiment and are spaced apart from each other in the vertical direction H. The sensing zone 40 that is delimited in the vertical direction H by the sensing areas 50 is formed between the two sensing areas 50.

The sensing zone 40 is open in the longitudinal direction L and the transverse direction Q. In these directions, it is determined by the dimension of the sensing areas 50 in the longitudinal direction L and the transverse direction Q, in particular the extension of the region of the sensing areas 50 which comprise the openings 54.

The openings 54 are provided in the sensing areas 50, wherein each sensing area 50 comprises just as many openings 54 as ducts 48 in the corresponding section 42, 44.

The openings 54 have an opening direction that is in particular perpendicular to the sensing area 50, thus runs in the shown embodiment in the vertical direction H.

As can be seen in FIG. 3, the openings 54 of each sensing area 50 are arranged in rows of multiple openings 54 that extend in the longitudinal direction L. In the shown embodiment, five openings 54 are each provided in one row.

In the transverse direction Q, multiple rows are arranged one behind the other; in the shown embodiment, there are two rows of openings 54.

In the shown embodiment, each sensing area 50 thus each has 10 openings 54 that are arranged in a regular grid. The openings 54 are thus arranged adjacent to each other.

It is also conceivable that the openings 54 of adjacent rows are offset in the longitudinal direction L. This offset can amount to half of the spacing (midpoint to midpoint) between two openings 54 in a row.

As can be seen in FIG. 4, each of the openings 54 of the sensing area 50 of the first section 42 has a corresponding opening 54 of the sensing area 50 of the second section 44.

The mutually corresponding openings 54 of the first and second section 42, 44 are aligned to each other.

The openings 54 and thus the sensing zone 40 are connected fluidly to the fluid ports 46 of the first and second section 42, 44.

The fluid connection occurs by means of the transition cavity 52 and the ducts 48.

The fluid port 46 and the opening of the fluid port 46 open into the transition cavity 52.

The transition cavity 52 is a cavity within the first section 42 or the second section 44.

The ducts 48 of the corresponding section 42, 44 each originate from the transition cavity 52 of each of the sections 42, 44. For example, the ducts 48 originate from the side of the transition cavity 52 opposite the fluid port 46.

The ducts 48 open into the openings 54 of the corresponding sections 42, 44, wherein each one of the ducts 48 opens into one of the openings 54.

Starting from the transition cavity 52, the ducts 48 initially run parallel to each other in the longitudinal direction L and then in an arc towards the sensing area 50.

In variants of the embodiment, in which the sensing area 50 and the openings 54 are in the vertical direction H, the ducts 48 run in particular without an arc.

In the shown embodiment, the arc extends through an angle of 90°, wherein an angle between 80° and 100° is conceivable, according to the sensing area 50.

The ducts 48 run parallel to each other in the region of the openings 54. The arcs of the ducts 48 within one of the sections 42, 44 thus have different angle curves.

The length of the ducts 48 is greater than triple the opening width of one of the openings 54. Alternatively or additionally, the length of the ducts 48 is greater than 5 mm, in particular greater than 10 mm.

The ducts 48 can taper towards the openings 54. For example, the openings 54 at the mouth to the transition cavity 52 have a greater opening width as at the mouth to the openings 54.

In this way, a fluid connection is provided from the fluid port 46 of the first section 42 to the sensing zone 40 completely within the first section 42. The fluid connection comprises, for example, the transition cavity 52 and the ducts 48.

In the same way, a fluid connection is provided from the fluid port 46 of the second section 44 to the sensing zone 40 that runs completely within the second section 44. For example, the fluid connection comprises the transition cavity 52 and the ducts 48 of the second section 44.

For measurement and detection of an edge K of the material web B, the sensing head 32 is connected fluidly by means of the fluid line to the compressed air source 34 and to the pressure sensor 36, for example by means of the fluid lines.

For example, the fluid port 46 of the first section 42 is connected fluidly by means of a fluid line to the compressed air source 34 and the fluid port 42 of the second section 44 is connected fluidly to the pressure sensor 36 by means of a fluid line.

In this way, the compressed air can be introduced through the first section 42 into the sensing zone 40, and through the second section 44, the pressure sensor 36 can determine the pressure on the sensing area 50 of the second section 44.

It is also conceivable that the fluid port 46 of the second section 44 is connected fluidly to the compressed air source 34 and the fluid port 46 of the first section 42 to the pressure sensor 36.

For the measurement and detection of an edge K of the material web B, the material web B, in particular with its edge K, is guided through the sensing zone 40.

In doing so, the material web B covers several of the openings 54 so that the compressed air flowing out of the openings 54 of the second section 44 (or the first section 42) does not reach the corresponding openings 54 in the sensing area 50 of the second section 44 (or the first section 42).

The pressure determined by the pressure sensor 36 is thus less than would be the case if the material web B would not be situated in the sensing zone 40, wherein the lower the pressure, the further the material web B is situated in the sensing zone 40.

Using the measured pressure, it is possible to infer the position of the edge K within the sensing zone 40, wherein the pressure is lower, the further the material web B runs into the sensing zone 40 in transverse direction Q.

Through the use of ducts 48, a particularly precise sensing head 32 and thus a precise edge sensor 28 are provided. Through the use of ducts 48, a uniform flow of air is generated through the sensing zone 40, thereby achieving a larger usable sensing zone as well as better linearity. This is improved as the ducts 48 or the flows guided in them to the openings 54 cannot affect each other.

1. A sensing head for a pneumatic edge sensor for detecting the position of an edge (K) of a material web (B), comprising:
a head part and a sensing zone,
wherein the head part comprises a first section and a second section, wherein the sensing zone is located between the first section and a second section,
wherein both the first section and a second section comprise a fluid port, a plurality of ducts and a sensing area with openings,
wherein the sensing areas of the first section and the second section delimit the sensing zone,
wherein the sensing zone is connected to the fluid port of the first section by means of a fluid connection through the first section, wherein the fluid connection is realised at least in part through the openings and the ducts of the first section, and
wherein the sensing zone is connected to the fluid port of the second section by means of a fluid connection through the second section, wherein the fluid connection is realised at least in part through the openings and the ducts of the second section.

2. The sensing head according to claim 1, wherein each of the ducts opens in one of the openings of the sensing area of the corresponding section, wherein the ducts taper towards the openings.

3. The sensing head according to claim 1, wherein the ducts run at least in part in an arc, in particular which extend through an angle of between 80° and 100°.

4. The sensing head according to claim 1, wherein the ducts have a length of more than 5 mm, and/or have a length that is larger than triple the opening width of one of the openings.

5. The sensing head according to claim 1, wherein the opening direction of the fluid port of the first section and/or the second section is angled, perpendicular to the opening direction of the openings of the sensing area of the first section and/or the second section.

6. The sensing head according to claim 1, wherein the sensing areas of the first section and the second section are opposite each other, in particular parallel to each other.

7. The sensing head according to claim 1, wherein the sensing area is flat and/or is only provided on one side of the corresponding section.

8. The sensing head according to claim 1, wherein the sensing areas of the first section and the second section are spaced apart from each other in the vertical direction (H) of the sensing head, wherein the openings of the sensing area of the first section (and/or the sensing area of the second section are arranged adjacent to each other in the longitudinal direction (L) and/or the transverse direction (Q).

9. The sensing head according to claim 1, wherein the openings of the sensing area of the first section and/or the sensing area of the second section are arranged in at least a row that extends in the longitudinal direction (L).

10. The sensing head according to claim 9, wherein at least two rows of openings are provided that are arranged adjacent to each other in the transverse direction (Q), wherein the openings form a regular grid.

11. The sensing head according to claim 1, wherein the openings of the sensing area of the first section and the opposing opening of the sensing area of the second section are aligned to each other.

12. The sensing head according to claim 1, wherein the first section and the second section are designed as a single piece, wherein the entire sensing head is a single piece.

13. The sensing head according to claim 1, wherein a transition cavity is arranged in the first section and/or in the second section, into said transition cavity the fluid port and the ducts of the corresponding sections open, wherein the fluid port and the ducts open into the transition cavity on the opposing sides.

14. An edge sensor for detecting the position of an edge (K) of a material web (B), comprising a sensing head according to claim 1, a compressed air source, and a pressure sensor,
wherein the compressed air source and the pressure sensor are connected fluidly to different ones of the fluid ports of the sensing head.

15. A unit for producing a material web (B), comprising an edge sensor according to claim 14, wherein the material web (B) extends through the sensing zone.
